(19) United States
(12) Patent Application Publication
(10) Pub. No.: US 2025/0063251 A1
(43) Pub. Date: Feb. 20, 2025

(54) INFORMATION PROCESSING APPARATUS AND INFORMATION PROCESSING METHOD

(71) Applicant: SONY GROUP CORPORATION, TOKYO (JP)

(72) Inventors: TOMOHIRO NISHI, TOKYO (JP); MASATOSHI YOKOKAWA, TOKYO (JP)

(21) Appl. No.: 18/706,035

(22) PCT Filed: Oct. 18, 2022
(86) PCT No.: PCT/JP2022/038659

§ 371 Date: Apr. 30, 2024

(30) Foreign Application Priority Data
Nov. 8, 2021 (JP) 2021-181907

(51) Int. Cl. H04N 23/60; G06F 3/01; G06T 3/40; G06T 7/20; G06T 7/70; G06V 40/16; H04N 23/69

(52) U.S. Cl. CPC H04N 23/64; G06F 3/013; G06T 3/40; G06T 7/20; G06T 7/70; G06V 40/161; H04N 23/69; G06T 2207/30201

(57) ABSTRACT

An information processing apparatus (10) has: a detection unit (21) that detects a relative position between a user who is imaged by any one of a plurality of cameras (12, 13) and a sensor on a basis of detection data obtained by the sensor; a first calculation unit (22) that calculates, on a basis of the relative position, a tolerance indicating difficulty for the user to notice switching of a camera that images; and a selection unit (25) that selects a camera that images a subject from the plurality of cameras on a basis of the calculated tolerance.

### FIELD

The present disclosure relates to an information processing apparatus and an information processing method.

### BACKGROUND

In a case where a camera is provided in a terminal having a limited thickness such as a smartphone, a plurality of cameras such as a wide-angle camera and a telephoto camera are selectively used in accordance with a zoom magnification. In addition, there is known a technique for generating a high-quality composite image by executing synthesis processing of a color image and a black-and-white image photographed from different viewpoints.

### CITATION LIST

### Patent Literature

Patent Literature 1: JP 2019-129446 A

### SUMMARY

### Technical Problem

However, in the above-described related art, when a composite image based on a color image and a composite image based on a black-and-white image are switched in accordance with a photographing situation, the switching may occur frequently. When switching frequently occurs between images having different viewpoints, line-of-sight movement based on parallax between the two images occurs, and a user observing the image feels uncomfortable.

Therefore, the present disclosure proposes an information processing apparatus and an information processing method capable of making it difficult to notice switching of a plurality of cameras.

### Solution to Problem

According to the present disclosure, an information processing apparatus includes: a detection unit that detects a relative position between a user who is imaged by any one of a plurality of cameras and a sensor on a basis of detection data obtained by the sensor; a first calculation unit that calculates, on a basis of the relative position, a tolerance indicating difficulty for the user to notice switching of a camera that images; and a selection unit that selects a camera that images a subject from the plurality of cameras on a basis of the calculated tolerance.

### BRIEF DESCRIPTION OF DRAWINGS

FIG. 1 is a diagram illustrating one example of a configuration of an information processing apparatus according to an embodiment of the present disclosure.

FIG. 2 is a diagram illustrating one example of imaging ranges of rear cameras.

FIG. 3 is a flowchart illustrating one example of camera switching processing.

FIG. 4 is a diagram illustrating one example of a configuration of an information processing apparatus according to a modification.

FIG. 5 is a hardware configuration diagram illustrating one example of a computer that implements functions of the information processing apparatus.

### DESCRIPTION OF EMBODIMENTS

Hereinafter, embodiments of the present disclosure will be described in detail with reference to the drawings. Note that in each of the following embodiments, the same units are denoted by the same reference numerals, and redundant description will be omitted.

The present disclosure will be described according to the following order of items.
1. Embodiment
1-1. Configuration of information processing apparatus according to embodiment
1-2. Procedure of information processing according to embodiment
2. Modification of Embodiment
3. Hardware Configuration
4. Effects

### 1. Embodiment

### [1-1. Configuration of Information Processing Apparatus According to Embodiment]

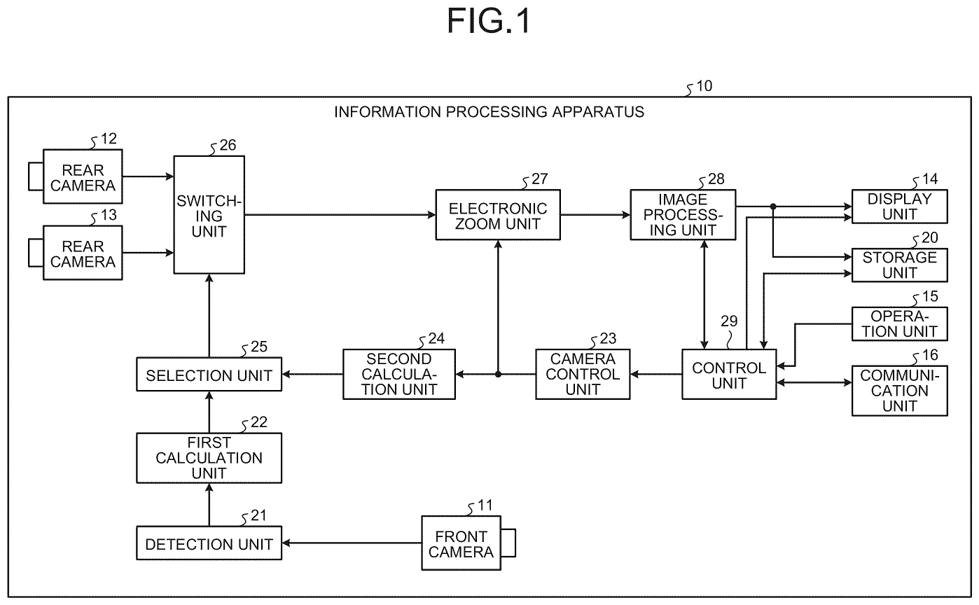

FIG. 1 is a diagram illustrating one example of a configuration of an information processing apparatus according to an embodiment of the present disclosure. As illustrated in FIG. 1, an information processing apparatus 10 has a front camera 11, rear cameras 12, 13, a display unit 14, an operation unit 15, a communication unit 16, a storage unit 20, a detection unit 21, a first calculation unit 22, a camera control unit 23, a second calculation unit 24, a selection unit 25, a switching unit 26, an electronic zoom unit 27, an image processing unit 28, and a control unit 29. Examples of the information processing apparatus 10 include a smartphone.

The front camera 11 is provided on a front side where the display unit 14 and the operation unit 15 of the information processing apparatus 10 are disposed, and can image a face of a user operating the information processing apparatus 10. The front camera 11 captures an image using, for example, a complementary metal oxide semiconductor (CMOS) image sensor, a charge coupled device (CCD) image sensor, or the like as an imaging element. The front camera 11 photoelectrically converts light received by the imaging element and performs analog/digital (A/D) conversion to generate an image. The front camera 11 outputs the captured image to the detection unit 21. The front camera 11 is one example of a first camera. Note that although not illustrated, the captured image output from the front camera 11 may be input to the electronic zoom unit 27 and the image processing unit 28.

The rear cameras 12, 13 are provided on a back side of the information processing apparatus 10 and can image a subject. The rear cameras 12, 13 each capture an image using, for example, a CMOS image sensor, a CCD image sensor, or the like as an imaging element. The rear cameras 12, 13 each photoelectrically convert light received by the imaging element and performs analog/digital (A/D) conversion to generate an image. The rear cameras 12, 13 output the captured images to the switching unit 26. In addition, the rear camera 12 and the rear camera 13 are cameras having different magnifications. In the following description, as one example, it is assumed that the magnification of the rear camera 12 is 1 time and the magnification of the rear camera 13 is 2 times. Note that each of the rear cameras 12, 13 may be not only a camera with a fixed magnification but also a camera capable of optical zooming. Note that the rear cameras 12, 13 are examples of a second camera and a third camera, respectively. In addition, a number of rear cameras may be three or more.

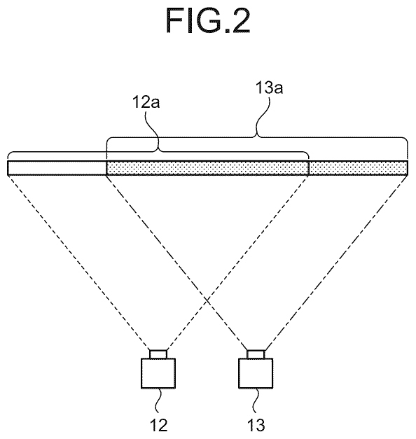

Here, imaging ranges in the rear cameras 12, 13 will be described with reference to FIG. 2. FIG. 2 is a diagram illustrating one example of the imaging ranges of the rear cameras. As illustrated in FIG. 2, the rear camera 12 and the rear camera 13 have different disposition positions on a back surface of the information processing apparatus 10, and thus have different imaging ranges. In the example of FIG. 2, an imaging range 12a of the rear camera 12 and an imaging range 13a of the rear camera 13 partially overlap but are different ranges. When the rear camera 12 and the rear camera 13 are switched in such a state, line-of-sight movement based on parallax between the two images occurs, and the user observing the image feels uncomfortable.

In contrast, in the above-described related art, movement of the captured image and movement of the camera are detected by a gyro sensor or the like, and the camera is switched at timing when the user hardly notices the switching in accordance with the detected movement. However, in a case where the user is performing photographing while moving, it is determined from the captured image, the gyro sensor, or the like that the camera is moving, but a relative position between the user and the camera does not change, and the camera is not moving as viewed from the user. Therefore, the user may notice switching of the camera.

The information processing apparatus 10 according to the present disclosure executes information processing described below in order to make it difficult for the user who possesses the information processing apparatus 10 including the cameras to notice switching of the plurality of cameras even while the user is moving. Specifically, the information processing apparatus 10 detects the relative position between the front camera 11 and the user on the basis of a position of a face of the user imaged by the front camera 11. The information processing apparatus 10 calculates a tolerance indicating difficulty for the user to noticing on the basis of the detected relative position. The information processing apparatus 10 selects one of the rear cameras 12, 13 that images the subject on the basis of the calculated tolerance.

The description returns to FIG. 1. The display unit 14 is a display device for displaying various types of information. The display unit 14 is realized by, for example, a liquid crystal display, an organic electro luminescence (EL) display, or the like as a display device. The display unit 14 displays various screens such as the captured image input from the image processing unit 28 and a display screen input from the control unit 29.

The operation unit 15 is an input device that receives various operations from the user of the information processing apparatus 10. The operation unit 15 is realized by, for example, a touch panel or the like as the input device. The display device of the display unit 14 and the input device of the operation unit 15 are integrated.

The communication unit 16 is realized by, for example, a communication module or the like corresponding to a wireless local area network (LAN) such as Wi-Fi (registered trademark), a third to fifth generation mobile communication system (3G to 5G), or the like. The communication unit 16 is a communication interface that manages communication of information with another information processing apparatus or the like.

The storage unit 20 is realized by, for example, a random access memory (RAM), a semiconductor memory element such as a flash memory, or a storage device such as a hard disk or an optical disk. The storage unit 20 stores the captured image and the like subjected to the image processing by the image processing unit 28. In addition, the storage unit 20 stores information (programs and data) used for the processing in the control unit 29.

The detection unit 21 to the control unit 29 are realized by, for example, a central processing unit (CPU), a micro processing unit (MPU), or the like executing programs stored in an internal storage apparatus using a RAM as a work area. Furthermore, the detection unit 21 to the control unit 29 may be realized by, for example, an integrated circuit such as an application specific integrated circuit (ASIC) or a field programmable gate array (FPGA).

When the captured image is input from the front camera 11, the detection unit 21 detects the position of the face of the user from the captured image. The detection unit 21 detects the position of the face of the user in three dimensions or two dimensions. The detection unit 21 detects the relative position between the front camera 11 and the user on the basis of the detected position of the face. Note that the detection unit 21 may obtain the position of the face from a distance to the face of the user using a distance measuring sensor such as a time of flight (TOF) sensor instead of the captured image. The relative position is, for example, information including coordinates of the position of the face inside the captured image. The detection unit 21 outputs, to the first calculation unit 22, the detected relative position between the front camera 11 and the user.

When the relative position between the front camera 11 and the user is input from the detection unit 21, the first calculation unit 22 calculates, on the basis of the relative position, the tolerance indicating the difficulty for the user to notice the switching of the camera that captures an image. For example, the first calculation unit 22 calculates the tolerance in accordance with a moving speed of the position of the face based on the coordinates of the position of the face included in the relative position. For example, the first calculation unit 22 calculates the tolerance such that the higher the moving speed of the position of the face is, the larger a value of the tolerance is. In addition, the first calculation unit 22 may calculate the tolerance in accordance with an acceleration of the position of the face. For example, the first calculation unit 22 may calculate the tolerance such that the higher the acceleration of the position of the face is, the larger the value of the tolerance is. The first calculation unit 22 outputs the calculated tolerance to the selection unit 25.

The camera control unit 23 calculates a zoom magnification desired by the user in accordance with user operation information input from the control unit 29. The camera control unit 23 outputs the calculated zoom magnification to the second calculation unit 24 and the electronic zoom unit 27. That is, the zoom magnification output from the camera control unit 23 is reflected on a zoom magnification of the image currently being captured in the electronic zoom unit 27.

When the zoom magnification is input from the camera control unit 23, the second calculation unit 24 calculates a necessity of switching between the rear camera 12 and the rear camera 13 on the basis of the input zoom magnification and a preset zoom magnification that requires switching of the camera. For example, during imaging by the rear camera 12 having a magnification of 1 time, a zoom operation is performed by electronic zoom so that the zoom magnification increases from 1 time, and when the zoom magnification becomes 2 times or more, an image quality will be improved by switching to the rear camera 13 having an optical magnification of 2 times. The second calculation unit 24 calculates the necessity of switching so that the necessity of switching becomes high in such a case. In addition, the second calculation unit 24 determines the switching destination camera.

For example, when the zoom magnification that requires the switching is a magnification A and the input zoom magnification (zoom magnification during current imaging) is a magnification B, the necessity of switching is obtained by a reciprocal of an absolute difference (1/|A−B|). In this case, the larger a numerical value of the necessity of switching is, the more necessary the switching of the camera is. In addition, the necessity of switching may have hysteresis by giving an offset value to the difference value. For example, when the zoom magnification is increased, the necessity of switching is set to (1/|A−B−C|), and when the zoom magnification is decreased, the necessity of switching is set to (1/|A−B+C|). However, C>0. In the case of providing the hysteresis, for example, when the zoom magnification is increased, the captured image of the rear camera 12 is zoomed in up to 1 to 2.2 times, and the camera is switched to the rear camera 13 at 2.2 times. On the other hand, when the zoom magnification is decreased, the captured image of the rear camera 13 is zoomed out from the magnification exceeding 2.2 times to 2 times, and the camera is switched to the rear camera 12 at 2 times. The second calculation unit 24 outputs, to the selection unit 25, the calculated necessity of switching and the switching destination camera.

To the selection unit 25, the tolerance is input from the first calculation unit 22, and the necessity of switching and the switching destination camera are input from the second calculation unit 24. The selection unit 25 selects the rear camera 12 or the rear camera 13 on the basis of the tolerance, and the necessity of switching and the switching destination camera, and outputs, to the switching unit 26, a camera selection signal for designating the selected camera. For example, the selection unit 25 multiplies the tolerance and the necessity of switching, and when the result is greater than or equal to a predetermined threshold value, the selection unit 25 selects the rear camera 12 or the rear camera 13 so as to switch the camera that is imaging. In addition, the selection unit 25 sets, as a switching threshold value, a value equal to or less than a value obtained by multiplying a minimum value of the tolerance and a maximum value of the necessity of switching, so that the camera can be switched when the necessity of switching reaches the maximum value. For example, if a value range of the tolerance is set to 1 to 100, a value range of the necessity of switching is set to 1 to 100, and the threshold is set to 100 or less, the necessity of switching becomes equal to or greater than the threshold value when the necessity of switching becomes 100, and thus the selection unit 25 can switch the camera.

When the camera selection signal is input from the selection unit 25, the switching unit 26 switches the captured image (video signal) to output to the electronic zoom unit 27 to the captured image of the rear camera 12 or the rear camera 13 designated by the camera selection signal. The switching unit 26 outputs camera information and the captured image after the switching to the electronic zoom unit 27. Note that the camera information includes information on the optical magnification of the camera being switched and selected.

To the electronic zoom unit 27, the zoom magnification is input from the camera control unit 23, and the camera information and the captured image are input from the switching unit 26. The electronic zoom unit 27 determines an electronic zoom magnification on the basis of the input zoom magnification and the optical magnification included in the camera information. The electronic zoom unit 27 executes electronic zoom processing of the determined electronic zoom magnification on the captured image. The electronic zoom unit 27 outputs the captured image after the electronic zoom to the image processing unit 28.

When the captured image is input from the electronic zoom unit 27, the image processing unit 28 performs various types of image processing on the captured image and displays the captured image after the image processing on the display unit 14. Note that examples of the image processing include adjustment of contrast, brightness, and the like. In addition, when instructed to store the captured image from the control unit 29, the image processing unit 28 stores the captured image after the image processing in the storage unit 20.

The control unit 29 controls each of the units of the information processing apparatus 10. For example, the control unit 29 receives an operation of the user input from the operation unit 15 via a user interface displayed on the display unit 14. The control unit 29 executes processing according to the received operation input. For example, when receiving a pinch-out operation for enlarging the captured image from the user, the control unit 29 outputs the pinch-out operation to the camera control unit 23 as the user operation information. In addition, the control unit 29 instructs the image processing unit 28 to store the image processing to be executed and the captured image. Furthermore, the control unit 29 may transmit the captured image that has been stored in the storage unit 20 to another information processing apparatus via the communication unit 16.

### [1-2. Procedure of Information Processing According to Embodiment]

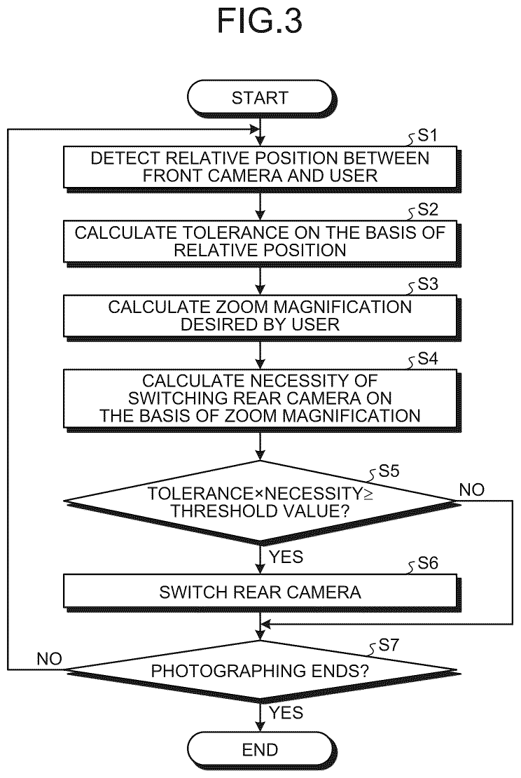

Next, camera switching processing for switching the rear camera on the basis of the relative position between the front camera and the user will be described with reference to FIG. 3. FIG. 3 is a flowchart illustrating one example of the camera switching processing.

As illustrated in FIG. 3, the control unit 29 of the information processing apparatus 10 starts photographing by the front camera 11 and the rear cameras 12, 13 on the basis of an instruction from the user. When the captured image is input from the front camera 11, the detection unit 21 detects the position of the face of the user from the captured image. The detection unit 21 detects the relative position between the front camera 11 and the user on the basis of the detected position of the face (Step S1). The detection unit 21 outputs, to the first calculation unit 22, the detected relative position between the front camera 11 and the user.

When the relative position between the front camera 11 and the user is input from the detection unit 21, the first calculation unit 22 calculates the tolerance on the basis of the relative position (Step S2). The first calculation unit 22 outputs the calculated tolerance to the selection unit 25.

The camera control unit 23 calculates a zoom magnification desired by the user in accordance with the user operation information (Step S3). The camera control unit 23 outputs the calculated zoom magnification to the second calculation unit 24 and the electronic zoom unit 27.

When the zoom magnification is input from the camera control unit 23, the second calculation unit 24 calculates the necessity of switching between the rear camera 12 and the rear camera 13 on the basis of the input zoom magnification and a preset zoom magnification that requires switching of the camera (Step S4). The second calculation unit 24 outputs the calculated necessity of switching to the selection unit 25.

To the selection unit 25, the tolerance is input from the first calculation unit 22, and the necessity of switching is input from the second calculation unit 24. The selection unit 25 determines whether or not the value obtained by multiplying the tolerance and the necessity of switching is equal to or larger than the threshold value (Step S5). When determining that the value obtained by multiplying the tolerance and the necessity of switching is equal to or larger than the threshold value (Step S5: Yes), the selection unit 25 selects the rear camera 12 or the rear camera 13 to be switched to, and outputs the camera selection signal designating the selected camera to the switching unit 26. On the other hand, when determining that the value obtained by multiplying the tolerance and the necessity of switching is less than the threshold value (Step S5: No), the selection unit 25 continues to select the currently used camera, and thus does not output the camera selection signal to the switching unit 26, and the processing proceeds to Step S7.

When the camera selection signal is input from the selection unit 25, the switching unit 26 switches the captured image to output to the electronic zoom unit 27 to the captured image of the rear camera 12 or the rear camera 13 designated by the camera selection signal (Step S6). The switching unit 26 outputs camera information and the captured image after the switching to the electronic zoom unit 27. Note that in a case where the currently used camera is continuously selected, the switching unit 26 outputs the camera information and the captured image of the currently used camera to the electronic zoom unit 27.

The electronic zoom unit 27 determines the electronic zoom magnification on the basis of the input zoom magnification and the optical magnification included in the camera information. The electronic zoom unit 27 executes the electronic zoom processing of the determined electronic zoom magnification on the captured image. The electronic zoom unit 27 outputs the captured image after the electronic zoom to the image processing unit 28. When the captured image is input from the electronic zoom unit 27, the image processing unit 28 performs various types of image processing on the captured image and displays the captured image after the image processing on the display unit 14. Thereafter, in a case where there is an instruction to store the captured image from the user, the control unit 29 memorizes and stores the captured image being displayed in the storage unit 20. The control unit 29 determines whether or not an instruction to end the photographing is input from the user (Step S7).

In a case where the control unit 29 determines that the instruction to end the photographing is not input from the user (Step S7: No), the processing returns to Step S1, and the photographing is continued. In a case where the control unit 29 determines that the instruction to end the photographing is input from the user (Step S7: Yes), the control unit 29 ends the camera switching processing. This makes it difficult to notice the switching of the plurality of cameras.

### 2. Modification of Embodiment

Meanwhile, in the above-described embodiment, the relative position between the front camera 11 and the user is detected on the basis of the position of the face of the user, but the relative position may be detected on the basis of a position of eyes and a line of sight of the user, and this case will be described as a modification. Note that in the modification, the same reference numerals are given to the same configurations as those of the information processing apparatus 10 of the above-described embodiment, and description of the overlapping configurations and operations will be omitted.

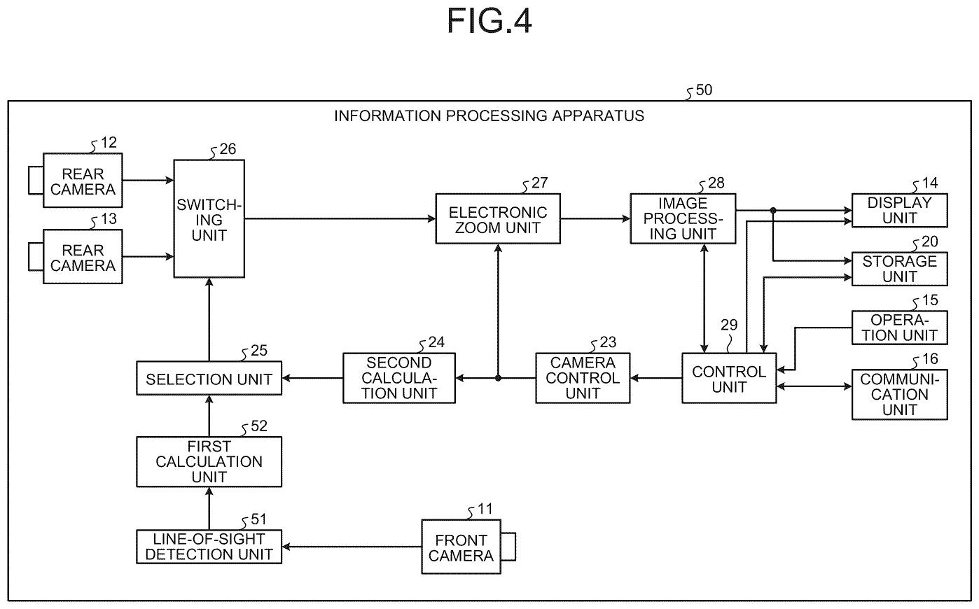

FIG. 4 is a diagram illustrating one example of a configuration of an information processing apparatus according to the modification. An information processing apparatus 50 illustrated in FIG. 4 has a line-of-sight detection unit 51 and a first calculation unit 52 instead of the detection unit 21 and the first calculation unit 22 of the information processing apparatus 10 described above. When the captured image is input from the front camera 11, the line-of-sight detection unit 51 detects the position of the eyes and the line of sight of the user from the captured image. The line-of-sight detection unit 51 detects the relative position between the front camera 11 and the user on the basis of the detected position of the eyes. In the modification, the relative positions are, for example, information including coordinates of the position of the eyes inside the captured image. The line-of-sight detection unit 51 outputs, to a first calculation unit 52, the detected relative position between the front camera 11 and the user, and line-of-sight information.

When the relative position between the front camera 11 and the user and the line-of-sight information are input from the line-of-sight detection unit 51, the first calculation unit 52 calculates, on the basis of the relative position and the line-of-sight information, the tolerance indicating the difficulty for the user to notice the switching of the camera. For example, the first calculation unit 52 calculates the tolerance in accordance with a moving speed of the position of the eyes based on coordinates of the position of the eyes included in the relative position, and the line-of-sight information. For example, the first calculation unit 52 calculates the tolerance such that the higher the moving speed of the position of the eyes is and the more the line of sight of the line-of-sight information deviates from a center of the display unit 14, the larger the value of the tolerance becomes. Note that the first calculation unit 52 may calculate the tolerance such that the higher a moving speed of the line of sight is, the larger the value of the tolerance is. In addition, the first calculation unit 52 may calculate the tolerance in accordance with an acceleration of the position of the eyes and the line-of-sight information. The first calculation unit 22 outputs the calculated tolerance to the selection unit 25. In this manner, the relative position between the front camera 11 and the user can be detected by using the position of the eyes and the line of sight of the user, and the rear cameras 12, 13 can be switched when the line of sight is moved even in a case where the relative position does not change.

In addition, the processing according to the above-described embodiment may be performed in various different embodiments other than the above-described embodiment.

In the above embodiment, a smartphone has been described as one example of the information processing apparatus 10, but the present invention is not limited thereto. For example, the present invention may be applied to an in-vehicle camera such as a back monitor or a camera such as an interphone.

In addition, the processing procedures, the specific names, and the information including various data and parameters illustrated in the document and the drawings described above can be arbitrarily changed unless otherwise specified. For example, the various types of information illustrated in each of the figures are not limited to the illustrated information.

In addition, each component of each of the apparatus illustrated in the drawings is functionally conceptual, and is not necessarily physically configured as illustrated in the drawings. That is, a specific form of distribution and integration of each of the apparatuses is not limited to an illustrated form, and all or a part thereof can be functionally or physically distributed and integrated in an arbitrary unit in accordance with various loads, usage conditions, and the like. For example, the camera control unit 23 and the control unit 29 may be integrated.

In addition, the above-described embodiment and modification can be appropriately combined within a range in which the processing contents are inconsistent.

### 3. Hardware Configuration

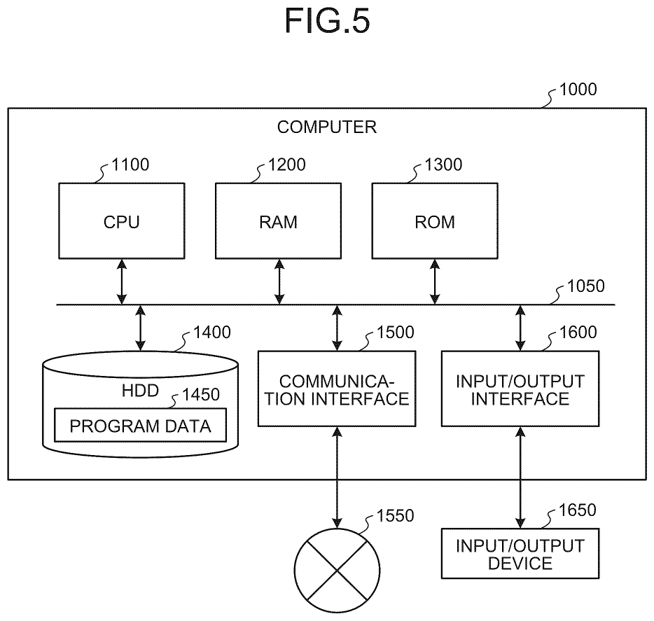

Information equipment such as the information processing apparatuses 10, 50 according to the above-described embodiments are realized by a computer 1000 having a configuration as illustrated in FIG. 5, for example. Hereinafter, the information processing apparatus 10 that is the information processing apparatus according to the embodiment will be described as an example. FIG. 5 is a hardware configuration diagram illustrating one example of the computer that implements the functions of the information processing apparatus. The computer 1000 has a CPU 1100, a RAM 1200, a read only memory (ROM) 1300, a hard disk drive (HDD) 1400, a communication interface 1500, and an input/output interface 1600. Each of the units of the computer 1000 is connected by a bus 1050.

The CPU 1100 operates on the basis of programs stored in the ROM 1300 or the HDD 1400, and controls each of the units. For example, the CPU 1100 develops the programs stored in the ROM 1300 or the HDD 1400 in the RAM 1200, and executes processing corresponding to the various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records the programs executed by the CPU 1100, data used by the programs, and the like. Specifically, the HDD 1400 is a recording medium that records an information processing program according to the present disclosure as one example of program data 1450.

The communication interface 1500 is an interface for the computer 1000 to connect to an external network 1550 (for example, the Internet). For example, the CPU 1100 receives data from other equipment or transmits data generated by the CPU 1100 to other equipment via the communication interface 1500.

The input/output interface 1600 is an interface for connecting an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a media interface that reads a program or the like recorded on a predetermined recording medium (medium). The medium is, for example, an optical recording medium such as a digital versatile disc (DVD) or a phase change rewritable disk (PD), a magneto-optical recording medium such as a magneto-optical disk (MO), a tape medium, a magnetic recording medium, a semiconductor memory, or the like.

For example, in a case where the computer 1000 functions as the information processing apparatus 10 according to the embodiment, the CPU 1100 of the computer 1000 implements the functions of the detection unit 21 and the like by executing the information processing program loaded on the RAM 1200. In addition, the HDD 1400 stores the information processing program according to the present disclosure and the data of the storage unit 20 and the like. Note that the CPU 1100 reads the program data 1450 from the HDD 1400 and executes the program data, but as another example, these programs may be acquired from another apparatus via the external network 1550.

### 4. Effects

The information processing apparatus 10 has the detection unit 21, the first calculation unit 22, and the selection unit 25. The detection unit 21 detects the relative position between the sensor and the user who is imaged by any one of the plurality of cameras (rear cameras 12, 13) on the basis of the detection data by the sensor. The first calculation unit 22 calculates, on the basis of the relative position, the tolerance indicating the difficulty for the user to notice switching of the camera that images. The selection unit 25 selects the camera that images a subject from the plurality of cameras on the basis of the calculated tolerance. This makes it difficult to notice the switching of the plurality of cameras.

The sensor is the first camera (front camera 11), and the detection unit 21 detects the relative position on the basis of the position of the face of the user imaged by the first camera. This makes it difficult to notice the switching of the plurality of cameras.

The first calculation unit 22 calculates the tolerance in accordance with the moving speed of the position of the face. As a result, it is possible to indicate that the user is not gazing at the display unit 14 of the information processing apparatus 10 as the tolerance.

The plurality of cameras includes the second camera (rear camera 12) and the third camera (rear camera 13) having different magnifications, and the information processing apparatus 10 further includes the second calculation unit 24. The second calculation unit 24 calculates the necessity of switching between the second camera and the third camera on the basis of a first zoom magnification for switching between the second camera and the third camera and a second zoom magnification of the image being captured. As a result, the camera can be switched in accordance with the necessity of switching the camera.

The selection unit 25 selects the second camera or the third camera on the basis of the tolerance and the necessity. As a result, the camera can be switched in accordance with the tolerance and the necessity.

The selection unit 25 sets a value equal to or less than the value obtained by multiplying the minimum value of the tolerance and the maximum value of the necessity as the switching threshold value in the selection between the second camera and the third camera. As a result, when the necessity is the maximum value, the camera can be switched.

The second calculation unit 24 calculates the necessity with the hysteresis. As a result, frequent switching of the camera can be suppressed.

The sensor is a distance measuring sensor, and the detection unit 21 detects the relative position on the basis of the position of the face obtained from the distance to the face of the user measured by the distance measuring sensor. This makes it difficult to notice the switching of the plurality of cameras.

The first calculation unit 22 calculates the tolerance in accordance with the acceleration of the position of the face. As a result, it is possible to indicate that the user is not gazing at the display unit 14 of the information processing apparatus 10 as the tolerance.

The sensor is the first camera, the detection unit (line-of-sight detection unit 51) detects the relative position and the line of sight on the basis of the position of the eyes of the user imaged by the first camera, and the first calculation unit 52 calculates the tolerance indicating the difficulty for the user to notice on the basis of the relative position and the line of sight. This makes it difficult to notice the switching of the plurality of cameras.

The information processing apparatus 10 further has the electronic zoom unit 27 that performs electronic zoom on the captured image output from the selected second camera or the third camera. As a result, the electronic zoom can be performed on the captured image.

The second zoom magnification is a magnification based on the magnification of the second camera or the third camera and the magnification of the electronic zoom. As a result, it is possible to perform zooming in which the optical magnification and the magnification of the electronic zoom are combined.

Note that the effects described in the present specification are merely examples and are not limited, and other effects may be provided.

Note that the present technology can also have configurations below.

(1)

An information processing apparatus comprising:
a detection unit that detects a relative position between a user who is imaged by any one of a plurality of cameras and a sensor on a basis of detection data obtained by the sensor;
a first calculation unit that calculates, on a basis of the relative position, a tolerance indicating difficulty for the user to notice switching of a camera that images; and
a selection unit that selects a camera that images a subject from the plurality of cameras on a basis of the calculated tolerance.
   (2)

The information processing apparatus according to (1), wherein
the sensor is a first camera, and
the detection unit detects the relative position on a basis of a position of a face of the user imaged by the first camera.
   (3)

The information processing apparatus according to (2), wherein
the first calculation unit calculates the tolerance in accordance with a moving speed of the position of the face.
   (4)

The information processing apparatus according to any one of (1) to (3), wherein
the plurality of cameras includes a second camera and a third camera having different magnifications, and
the information processing apparatus further comprises a second calculation unit that calculates a necessity of switching between the second camera and the third camera on a basis of a first zoom magnification for switching between the second camera and the third camera and a second zoom magnification of an image being captured.
   (5)

The information processing apparatus according to (4), wherein
the selection unit selects the second camera or the third camera on a basis of the tolerance and the necessity.
   (6)

The information processing apparatus according to (5), wherein
the selection unit sets a value equal to or less than a value obtained by multiplying a minimum value of the tolerance and a maximum value of the necessity as a switching threshold value in the selection between the second camera and the third camera.
   (7)

The information processing apparatus according to (4) or (5), wherein
the second calculation unit calculates the necessity with hysteresis.
   (8)

The information processing apparatus according to (1), wherein
the sensor is a distance measuring sensor, and
the detection unit detects the relative position on a basis of a position of a face obtained from a distance to the face of the user measured by the distance measuring sensor.
   (9)

The information processing apparatus according to (2), wherein
the first calculation unit calculates the tolerance in accordance with an acceleration of the position of the face.
   (10)

The information processing apparatus according to (1), wherein
the sensor is a first camera,
the detection unit detects the relative position and detects a line of sight on a basis of a position of an eye of the user imaged by the first camera, and
the first calculation unit calculates the tolerance indicating the difficulty for the user to notice on a basis of the relative position and the line of sight.
   (11)

The information processing apparatus according to any one of (5) to (7), further comprising
an electronic zoom unit that performs electronic zoom on a captured image output from the selected second camera or third camera.
   (12)

The information processing apparatus according to (11), wherein
the second zoom magnification is a magnification based on the magnification of the second camera or the third camera and a magnification of the electronic zoom.
   (13)

An information processing method in which a computer executes processing of:
detecting a relative position between a user who is imaged by any one of a plurality of cameras and a sensor on a basis of detection data obtained by the sensor;
calculating, on a basis of the relative position, a tolerance indicating difficulty for the user to notice switching a camera that images; and
selecting a camera that images a subject from the plurality of cameras on a basis of the calculated tolerance.
   (14)

An information processing program that causes a computer to execute processing of:
detecting a relative position between a user who is imaged by any one of a plurality of cameras and a sensor on a basis of detection data obtained by the sensor;
calculating, on a basis of the relative position, a tolerance indicating difficulty for the user to notice switching of a camera that images; and
selecting a camera that images a subject from the plurality of cameras on a basis of the calculated tolerance.

### REFERENCE SIGNS LIST

10, 50 INFORMATION PROCESSING APPARATUS
11 FRONT CAMERA
12, 13 REAR CAMERA
14 DISPLAY UNIT
15 OPERATION UNIT
16 COMMUNICATION UNIT
20 STORAGE UNIT
21 DETECTION UNIT
22, 52 FIRST CALCULATION UNIT
23 CAMERA CONTROL UNIT
24 SECOND CALCULATION UNIT
25 SELECTION UNIT
26 SWITCHING UNIT
27 ELECTRONIC ZOOM UNIT
28 IMAGE PROCESSING UNIT
29 CONTROL UNIT
51 LINE-OF-SIGHT DETECTION UNIT

1. An information processing apparatus comprising:
a detection unit that detects a relative position between a user who is imaged by any one of a plurality of cameras and a sensor on a basis of detection data obtained by the sensor;
a first calculation unit that calculates, on a basis of the relative position, a tolerance indicating difficulty for the user to notice switching of a camera that images; and
a selection unit that selects a camera that images a subject from the plurality of cameras on a basis of the calculated tolerance.

2. The information processing apparatus according to claim 1, wherein
the sensor is a first camera, and
the detection unit detects the relative position on a basis of a position of a face of the user imaged by the first camera.

3. The information processing apparatus according to claim 2, wherein
the first calculation unit calculates the tolerance in accordance with a moving speed of the position of the face.

4. The information processing apparatus according to claim 1, wherein
the plurality of cameras includes a second camera and a third camera having different magnifications, and
the information processing apparatus further comprises a second calculation unit that calculates a necessity of switching between the second camera and the third camera on a basis of a first zoom magnification for switching between the second camera and the third camera and a second zoom magnification of an image being captured.

5. The information processing apparatus according to claim 4, wherein
the selection unit selects the second camera or the third camera on a basis of the tolerance and the necessity.

6. The information processing apparatus according to claim 5, wherein
the selection unit sets a value equal to or less than a value obtained by multiplying a minimum value of the tolerance and a maximum value of the necessity as a switching threshold value in the selection between the second camera and the third camera.

7. The information processing apparatus according to claim 4, wherein
the second calculation unit calculates the necessity with hysteresis.

8. The information processing apparatus according to claim 1, wherein
the sensor is a distance measuring sensor, and
the detection unit detects the relative position on a basis of a position of a face obtained from a distance to the face of the user measured by the distance measuring sensor.

9. The information processing apparatus according to claim 2, wherein
the first calculation unit calculates the tolerance in accordance with an acceleration of the position of the face.

10. The information processing apparatus according to claim 1, wherein
the sensor is a first camera,
the detection unit detects the relative position and detects a line of sight on a basis of a position of an eye of the user imaged by the first camera, and
the first calculation unit calculates the tolerance indicating the difficulty for the user to notice on a basis of the relative position and the line of sight.

11. The information processing apparatus according to claim 5, further comprising
an electronic zoom unit that performs electronic zoom on a captured image output from the selected second camera or third camera.

12. The information processing apparatus according to claim 11, wherein
the second zoom magnification is a magnification based on the magnification of the second camera or the third camera and a magnification of the electronic zoom.

13. An information processing method in which a computer executes processing of:
detecting a relative position between a user who is imaged by any one of a plurality of cameras and a sensor on a basis of detection data obtained by the sensor;
calculating, on a basis of the relative position, a tolerance indicating difficulty for the user to notice switching a camera that images; and
selecting a camera that images a subject from the plurality of cameras on a basis of the calculated tolerance.
